(19) United States
(12) Patent Application Publication
(10) Pub. No.: US 2014/0340367 A1
(43) Pub. Date: Nov. 20, 2014

(54) INTERACTIVE UNIT ATTACHMENT STRUCTURE FOR PROJECTOR

(71) Applicants: Kazuya Inoue, Tokyo (JP); Yoshinobu Moriya, Tokyo (JP); Toshiyuki Yamaguchi, Tokyo (JP)

(72) Inventors: Kazuya Inoue, Tokyo (JP); Yoshinobu Moriya, Tokyo (JP); Toshiyuki Yamaguchi, Tokyo (JP)

(21) Appl. No.: 14/345,162

(22) PCT Filed: Sep. 20, 2011
(86) PCT No.: PCT/JP2011/071358

§ 371 Date: Mar. 14, 2014

(51) Int. Cl. G06F 3/043; F16M 13/02; F16L 3/01; G06F 3/0354

(52) U.S. Cl. CPC G06F 3/043; G06F 3/03545; F16M 13/022; F16L 3/01
USPC 345/177; 353/119; 248/231.91; 248/65

(57) ABSTRACT

The present invention realizes an interactive unit attachment structure that enables a projector to have an electronic pen function regardless of the type of projection surface. The attachment structure of the interactive unit, which is provided with a first sensor and a second sensor and which is attached to a wall hanging unit that suspends the projector from the wall such that the interactive unit can slide in a direction projecting from the wall, includes a slot in a slot provided in the wall hanging unit that extends in the direction of sliding and first and second protrusions provided in the interactive unit that protrude into the slot.

### TECHNICAL FIELD

The present invention relates to an interactive unit for providing an electronic pen function to a projector.

### BACKGROUND ART

In recent years, electronic blackboard systems that employ ultrasonic waves and infrared light such as disclosed in Patent Document 1 (Japanese Unexamined Patent Application Publication No. 2007-58425) have come into wide use. In this type of electronic blackboard system, an electronic pen transmits ultrasonic waves and infrared light when pressed, and sensors that are provided in two locations and that detect the ultrasonic waves and infrared light are used to specify the position pressed by the electronic pen based on the time difference of detection of the ultrasonic waves and infrared beam that were transmitted by the electronic pen and the positions of the sensors and to then reflect this position on the image that is projected by a projector.

Patent Document 2 (Japanese Unexamined Patent Application Publication No. 2010-201807) discloses an interactive board that is equipped with a projector hanger for supporting a projector and a position detection sensor and that has, as an object, enabling the use of an interactive board that uses a position-detecting transmission/reception function and that can be adopted regardless of being previously provided or newly provided in various types of blackboards and whiteboards. Patent Document 2 describes cases in which the position detection sensor is incorporated into a wall hanging unit which hangs a projector on a wall or is installed on the board surface or on a portion of the board frame.

### LITERATURE OF THE PRIOR ART

### Patent Documents

Patent Document 1: Japanese Unexamined Patent Application Publication No. 2007-058425

Patent Document 2: Japanese Unexamined Patent Application Publication No. 2010-201807

### SUMMARY OF THE INVENTION

### Problem to be Solved by the Invention

When realizing an electronic blackboard system such as described in Patent Document 1, the positions of the sensors are used to identify the position at which an electronic pen is pressed, and the positions of the sensors are therefore of key importance.

The construction disclosed in Patent Document 2 assumes a case in which a sensor is incorporated into a wall hanging unit which hangs a projector on a wall and a case in which the sensor is installed on the board surface or on a portion of the board frame.

Apart from a whiteboard or a blackboard, a wall can also be offered as an example of a projection surface, but the wall hanging unit which hangs a projector on a wall disclosed in the cited Document 2 is assumed to be movable along the board and therefore cannot permit the use of a wall as a projection surface.

The present invention realizes an interactive unit attachment structure that enables a projector to have an electronic pen function regardless of the type of projection surface.

### BRIEF DESCRIPTION OF THE DRAWINGS

FIG. 1 is a perspective view showing the state of use of an exemplary embodiment of the electronic blackboard system that uses the interactive unit according to the present invention.

FIG. 2 is a block diagram showing the principal construction of the signal transmission system of the system shown in FIG. 1.

FIG. 3(a) and (b) show states of the attachment of interactive unit 100.

FIG. 4(a) and (b) show states of the attachment of interactive unit 100.

FIG. 5(a)-(c) show attachment positions of interactive unit 100.

FIG. 6(a)-(c) show attachment positions of interactive unit 100.

FIG. 7(a)-(c) show details of top cover 105 of interactive unit 100.

FIG. 8(a) and (b) show details of the top cover 105 of interactive unit 100.

### BEST MODE FOR CARRYING OUT THE INVENTION

An exemplary embodiment of the present invention is next described with reference to the accompanying drawings.

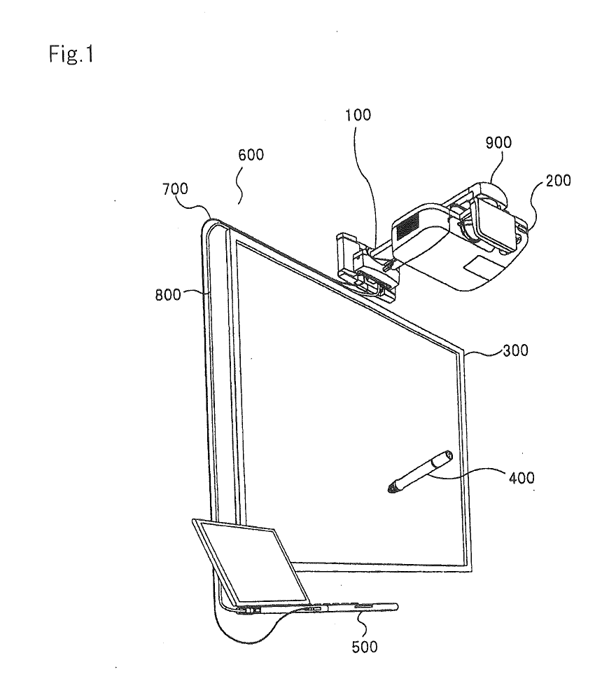

FIG. 1 is a perspective view showing the state of use of an exemplary embodiment of the electronic blackboard system that uses the interactive unit according to the present invention.

The electronic blackboard system shown in FIG. 1 is made up of: wall-hanging unit 900, projector 200 that is attached to wall 600 by wall-hanging unit 900, whiteboard 300 that is attached to wall 600, electronic pen 400 that transmits ultrasonic waves and infrared light when pressed, interactive unit 100 that receives ultrasonic waves and infrared light that are transmitted by electronic pen 400, and personal computer 500 that is connected to interactive unit 100 by way of USB (Universal Serial Bus) cable 700 and video cable 800.

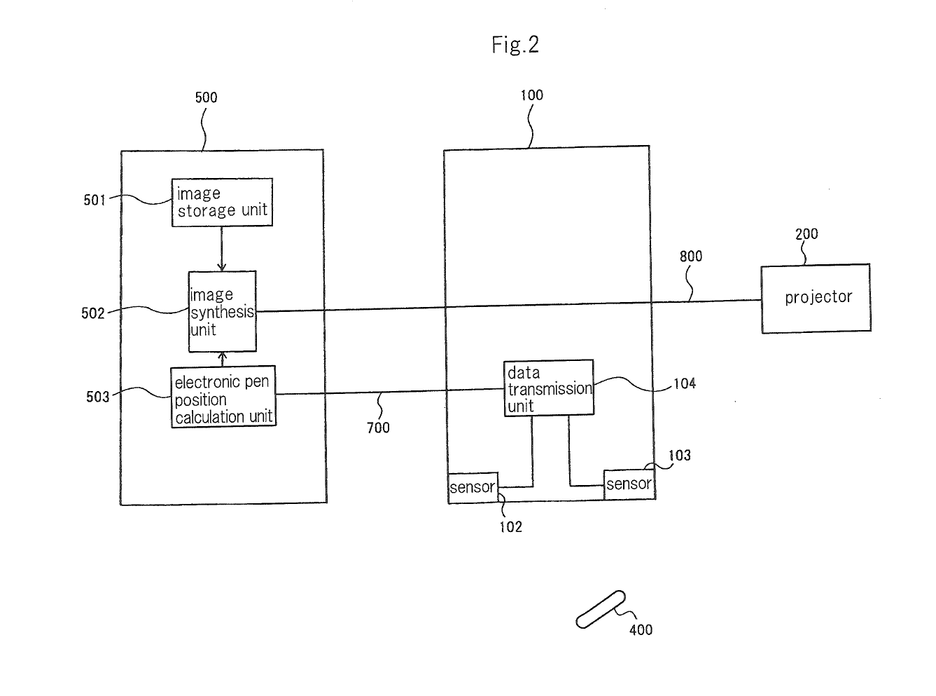

FIG. 2 is a block diagram showing the principal construction of the signal transmission system of the system shown in FIG. 1.

Sensors 102 and 103 that detect ultrasonic waves and infrared light that are transmitted when electronic pen 400 is pressed are provided on both ends of interactive unit 100, and the reception states of these sensors 102 and 103 are sent to electronic pen position calculation unit 503 in personal computer 500 by way of USB cable 700. In electronic pen position calculation unit 503, the position at which electronic pen 400 was pressed is specified based on the positions of sensors 102 and 103 and the reception times of the ultrasonic waves and infrared light of each of the sensors, and a signal indicating this content is supplied to image synthesis unit 502.

In addition to image synthesis unit 502 and electronic pen position calculation unit 503 described above, personal computer 500 is further provided with image storage unit 501. Image data transmitted in from, for example, a radio LAN (Local Area Network) and USB memory are stored in image storage unit 501 and sent to image synthesis unit 502. In image synthesis unit 502, the image indicated by the image data that were transmitted in from image storage unit 501 is combined with an image indicating the position at which electronic pen 400 was pressed that was sent in from electronic pen position calculation unit 503, and data indicating this synthesized image are transmitted to projector 200 by way of video cable 800. In projector 200, the synthesized image that is indicated by the data that were sent in is projected, the input to electronic pen 400 being reflected in the projected image.

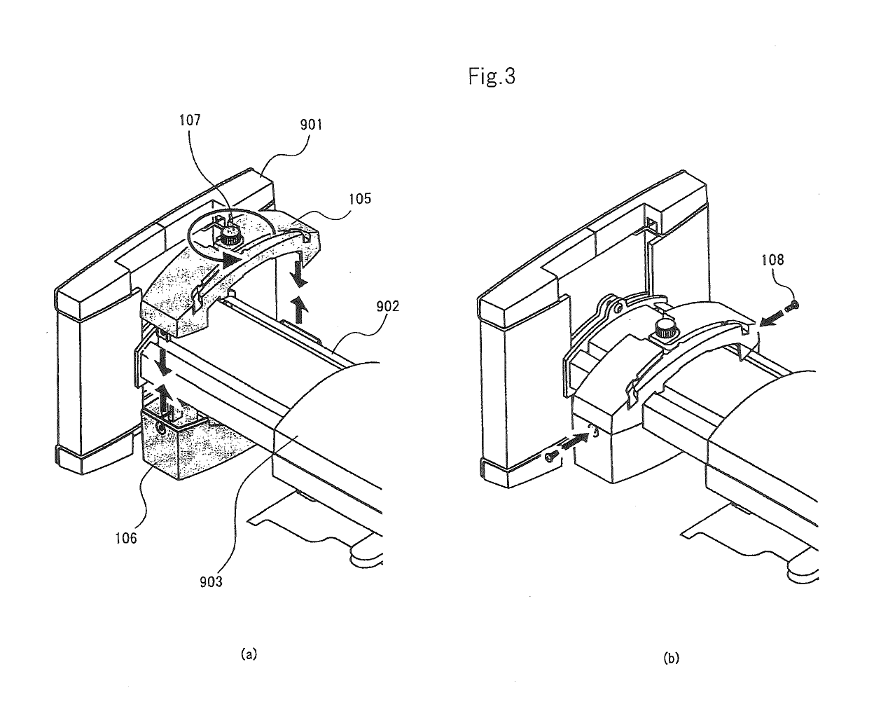

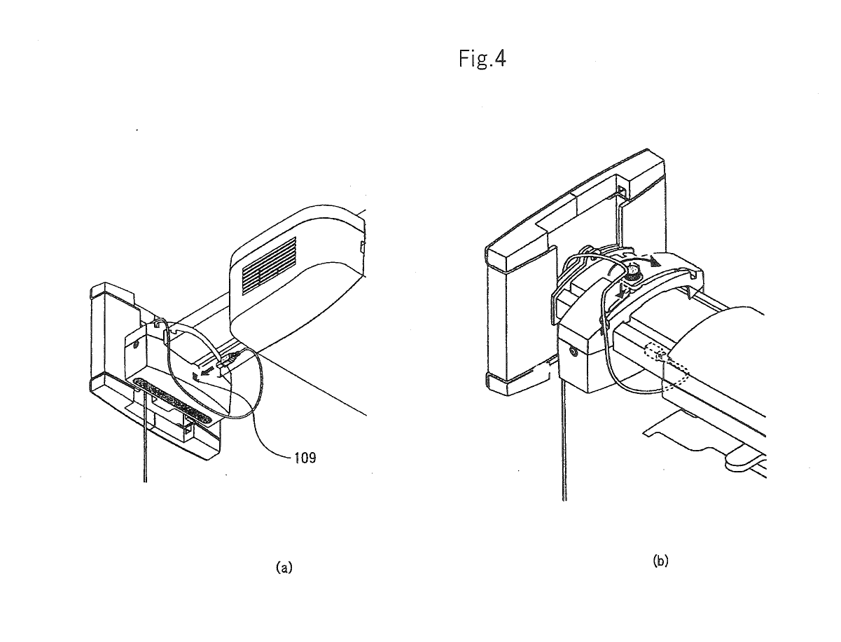

The attachment of interactive unit 100 is next described with reference to FIGS. 3 and 4.

As shown in FIG. 3(a), wall-hanging unit 900 is made up of: base 901 that is attached to wall 600; arm 902 that projects from base 901; and projector attachment unit 903 that is provided at the end of aim 902 and to which projector 200 is attached. Interactive unit 100 is attached to arm 902.

As shown in FIG. 3(a), interactive unit 100 is made up of top cover 105 and bottom cover 106 and is held in place by securing screws 108 on the right and left as shown in FIG. 3(b) in a state in which arm 902 is interposed between top cover 105 and bottom cover 106. Top cover 107 is further provided with adjustment dial 107 that changes the amount of protrusion of an adjustment screw (not shown) that protrudes toward the direction of arm 902 according to its state of rotation.

Next, as shown in FIG. 4(a), USB cable 700 is connected to USB port 109 that is provided on interactive unit 100. USB port 109 is connected to data transmission unit 104 shown in FIG.

2. Then, as shown in FIG. 4(b), interactive unit 100 is secured by rotating adjustment dial 107 to place the adjustment screw in a state that butts against arm 902.

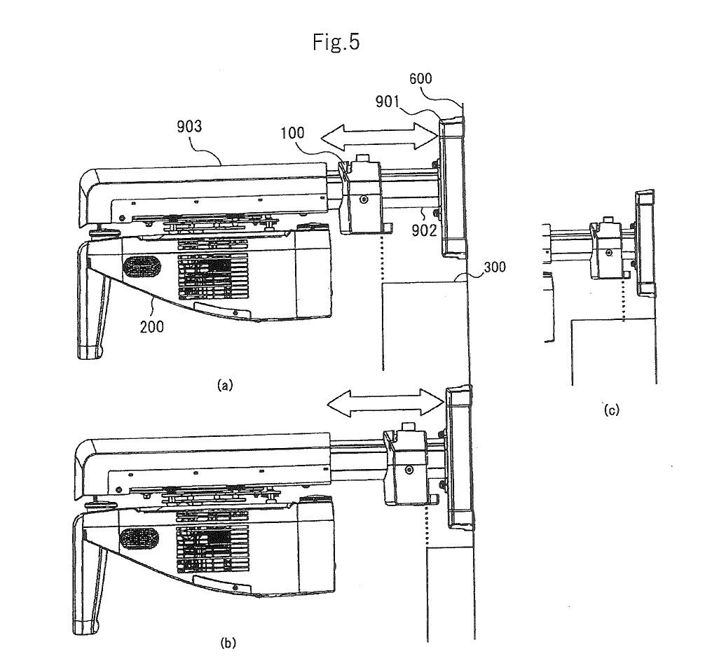

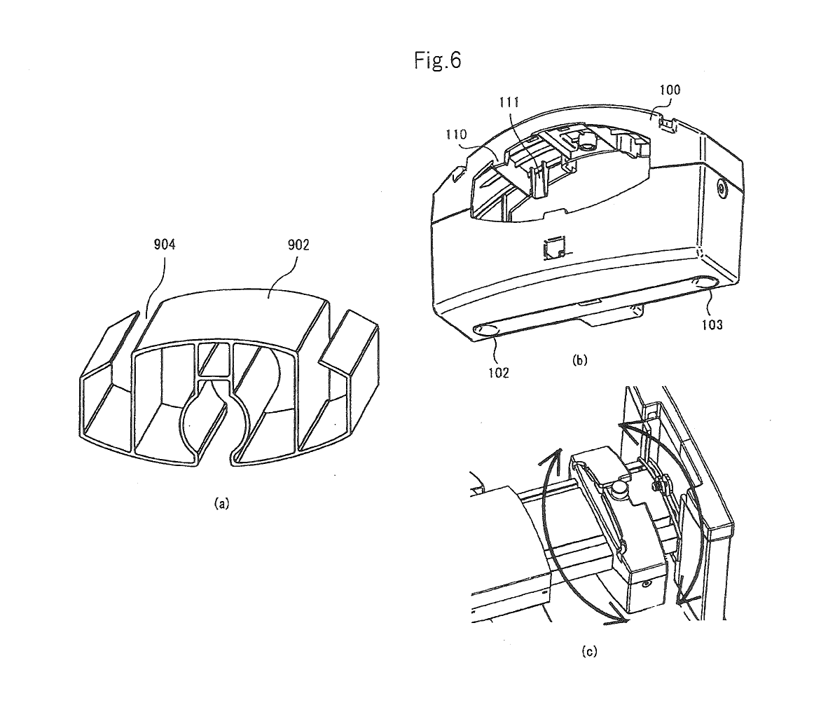

The attachment position of interactive unit 100 is next described with reference to FIGS. 5 and 6. FIG. 5 is a side view showing the attached state of interactive unit 100, and FIG. 6 shows the construction that ensures precise positioning while interactive unit 100 is being attached.

As shown in FIG. 5(a), projector 200 projects an image on whiteboard 300 while being suspended by projector attachment unit 903. Interactive unit 100 that is attached to arm 902 is secured by the attachment of base 901 to wall 600. When in the attached state shown in FIG. 5(a), sensors 102 and 103 are provided on the whiteboard 300-side of the bottom surface of interactive unit 100, as shown in FIG. 6(b).

Because above-described sensors 102 and 103 carry out sensing of ultrasonic waves and infrared light, sensors 102 and 103 do not operate when they are rearward of the surface of whiteboard 300, which is the projection surface and which is pressed by electronic pen 400, as shown in FIG. 5(c). In the present exemplary embodiment, the projection surface is assumed to be whiteboard 300 that has a certain degree of thickness, and sensors 102 and 103 do not operate properly if not installed at appropriate positions according to the thickness of whiteboard 300. Interactive unit 100 is able to slide along arm 902 as shown in FIGS. 5(a) and (b), whereby interactive unit 100 can be made compatible with all types of projection surfaces (such as cases of projecting directly on a wall or on a whiteboard or blackboard that has certain degree of thickness).

When rotation of the interactive unit occurs, when happens when it is caused to slide along arm 902 as shown in FIG. 6(c), the line that connects sensors 102 and 103, which is of key importance for detecting the position of electronic pen 400, becomes inclined with respect to the surface of whiteboard 300, whereby the accurate detection of the position of the interactive unit is no longer possible.

In order to prevent the occurrence of rotation such as shown in FIG. 6(c), slot 904 is formed in arm 902 along the direction in which interactive unit 100 shown in FIG. 6(a) slides, and protrusions 110 and 111, which are to be inserted into slot 904, are formed in top cover 105 of interactive unit 100 along the direction in which top cover 105 shown in FIG. 6(b) slides.

Interactive unit 100 thus slides while being guided by protrusions 110 and 111 that are inserted inside slot 904, whereby rotation such as shown in FIG. 6(c) does not occur. Alternatively, a long and narrow protrusion may be formed instead of providing two protrusions 110 and 111.

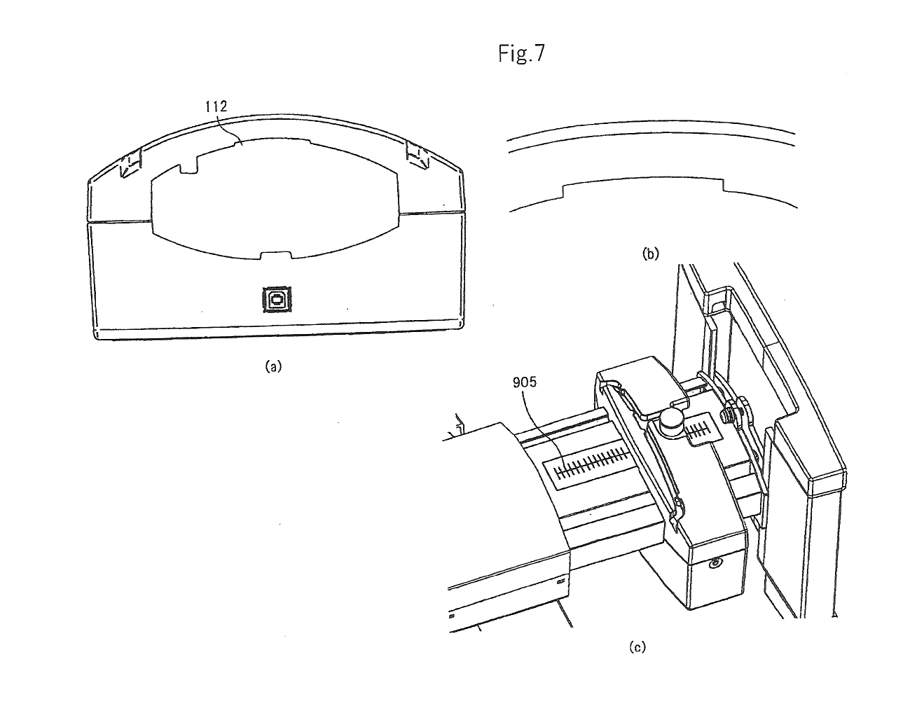

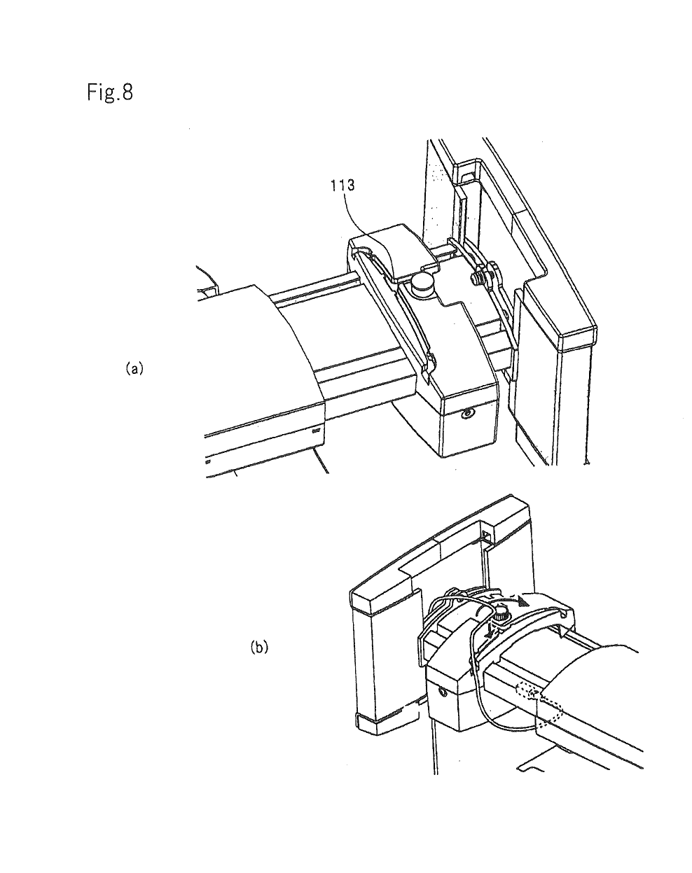

FIGS. 7 and 8 show details of top cover 105 of interactive unit 100.

When attaching interactive unit 100 to arm 902, adjustment dial 107 is turned to cause the adjustment screw to protrude as described hereinabove, but the concern arises that damage will occur to aim 902 at this time. To address his concern, arm 902 is prevented from being damaged by having label 905, which has a degree of thickness; adhere to arm 902 and then the adjustment screw butts against label 905, as shown in FIG. 7(c), that is attached to are 902. A scale is printed on label 905, and this scale facilitates setting to the appropriate position in a case in which the projection surface is a board having thickness.

Top cover 105 of interactive unit 100 is foamed to match the shape of the arm while taking into consideration the prevention of instability when attaching the interactive unit 100 to arm 902. In addition, notch 112 is formed to avoid label 905. FIG. 7(b) is an enlarged view showing notch 112. In the present exemplary embodiment that is provided with these constructions, the provision of label 905 will prevent damage to arm 902. In addition, the provision of notch 112 will enable smooth sliding of interactive unit 100.

In addition, wiring accommodation unit 113 is provided in top cover 105 of interactive unit 100, as shown in FIG. 8. As shown in FIG. 4(a), USB cable 700 is connected to USB port 109, and USB cable 700 is clamped (held) by wiring accommodation unit 113.

Interactive unit 100 is connected to personal computer 500. Interactive unit 100 is installed in an appropriate position with respect to the projection surface and is secured by the adjustment screw, but personal computer 500 has the capability of being carried about. If USB cable 700 should be pulled out while personal computer 500 is being carried, USB cable 700 must be reinserted in USB port 109. Although USB cable 700 can be easily reinserted should it be removed from the personal computer-500 side, USB port 109 is usually arranged in a high position and reinsertion is therefore extremely inconvenient.

Because the channel of USB cable 700 in an “S” shape, wiring accommodation unit 113 maintains a clamping force that can withstand a certain amount of tension, and by making the extraction of USB cable 700 more difficult on the USB port-109 side, the occurrence of reinsertion is prevented.

### EXPLANATION OF REFERENCE NUMBERS

100 interactive unit
200 projector
300 whiteboard
400 electronic pen
500 personal computer
600 wall
700 USB cable
800 video cable

What is claimed is:

1. An interactive unit attachment structure that is an attachment structure of an interactive unit that is equipped with a first sensor and a second sensor and that is attached to a wall-hanging unit that suspends a projector from a wall so as to allow sliding in the direction of projection from said wall, comprising:
a slot that is provided in said wall-hanging unit and that extends along the direction of said sliding; and
first and second protrusions that are provided on said interactive unit and that protrude into said slot.

2. The interactive unit attachment structure according to claim 1, wherein said interactive unit comprises an adjustment screw that butts against said wall-hanging unit.

3. The interactive unit attachment structure according to claim 1, wherein said wall-hanging unit comprises a label which includes printed scale.

4. The interactive unit attachment structure according to claim 3, wherein said interactive unit comprises a notch which is formed to avoid said label.

5. The interactive unit attachment structure according to claim 1, wherein said interactive unit comprises:
a port which is connected to a cable, and
a wiring accommodation unit which held said cable.

6. The interactive unit attachment structure according to claim 5, wherein said wiring accommodation unit has a channel which holds said cable in an “S” shape.

7. An electronic blackboard system, comprising:
a wall-hanging unit attached to a wall;
a projector attached to said wall-hanging unit;
a board onto which an image is projected from said projector; and
an interactive unit attached to said wall-hanging unit and that enables sliding in the direction of projection from said wall;
wherein said wall hanging unit includes a slot that extends along the direction of said sliding; and
wherein said interactive unit includes a first sensor and a second sensor, and first and second protrusions that protrude into said slot

8. An electronic blackboard system according to claim 7, further comprising;
an electronic pen that transmits ultrasonic wave when pressed; and
a computer that calculates the position of said electronic pen based on the reception time of the ultrasonic wave in said first sensor or said second sensor.

9. An electronic blackboard system according to claim 8,
wherein said computer combines said image with an image indicating the position of said electronic pen and transmits a combined image to said projector.
